(19) United States
(12) Patent Application Publication
(10) Pub. No.: US 2009/0174143 A1
(43) Pub. Date: Jul. 9, 2009

(54) Learning System and Method and Pattern Matching Design Game Implementing Same

(76) Inventor: Geoffrey Cox, Lupton (GB)

Correspondence Address: WILLIAMS MULLEN, 222 CENTRAL PARK AVENUE, SUITE 1700, VIRGINIA BEACH, VA, 23462, US

(21) Appl. No.: 12/348,056

(22) Filed: Jan. 2, 2009

Related U.S. Application Data
(60) Provisional application No. 61/009,997, filed on Jan. 4, 2008.

(51) Int. Cl. A63F 3/04; G09B 19/00; G09B 19/22

(52) U.S. Cl. 273/276; 434/237

(57) ABSTRACT

A set of different metal and rope components can be used by groups or individuals to match a pre-determined pattern. A game operator can provide the individual or team with individual assembly components and a pre-determined pattern diagram. The team is then required to configure the different available components so as to match the diagram. In one embodiment of the present invention, the diagram is provided in black-and-white and the assembly components are in color. In one embodiment, a game is provided whereby a team uses trial and error to first build the assembly of pieces to match the diagram. Next, the team must plan and rehearse a strategy for quickly re-assembling the pieces to match the diagram while being timed by a clock. The process in accordance with the present invention is self-checking in that there is only one unique solution to the pre-determined assembly.

### CROSS-REFERENCE TO RELATED APPLICATIONS

The present application claims the benefits of U.S. Provisional Application Ser. No. 61/009,997, filed Jan. 4, 2008 and having the same title, the disclosure of which is incorporated herein by reference in its entirety.

### FIELD OF THE INVENTION

The present invention relates to learning systems, and more particularly, to a pattern matching design game used as a learning tool for sharpening one or more skill sets associated with team projects, including planning, implementation, teamwork, monitoring, control, time management and process improvement, for example.

### BACKGROUND AND SUMMARY OF THE INVENTION

Learning tools have been provided to help individuals and teams of larger groups (e.g., from corporations) develop skills and learning habits in a variety of areas. For example, learning tools and activities can be designed to assist users in developing and expanding skills in leadership, influencing, facilitating, negotiation, communication, information management, cultural integration, planning, implementation, business relationships and networks, team dynamics, change management, creativity, business analysis, training, monitoring, control, process improvement, and sales. Such learning tools can work as “stand alone” activities, or can be incorporated as “building blocks” as part of a larger development program.

The present invention provides a set of different metal and rope components that can be used by groups or individually to match a pre-determined pattern. For example, a game operator can provide the individual or team with individual assembly components and a pre-determined pattern diagram. The team is then required to configure the different available components so as to match the diagram. In one embodiment of the present invention, the diagram is provided in black-and-white and the assembly components are in color.

In a further embodiment of the present invention, a game is provided whereby a team uses trial and error to first build the assembly of pieces to match the diagram. Next, the team must plan and rehearse a strategy for quickly re-assembling the pieces to match the diagram while being timed by a clock. The game can invoke a variety of rules to influence the difficulty of the game. For instance, one rule may provide that the individual pieces cannot be marked or pre-sorted. Another rule may provide that cord sections may only be connected in certain ways (e.g., red pieces always connect to other red pieces, short pieces always connect to long pieces, intermediate pieces always connect to other intermediate pieces, etc.).

The process in accordance with the present invention is self-checking in that there is only one unique solution to the pre-determined assembly. The present invention can be employed using teams of up to thirty or more people, although the challenge is greater with smaller numbers. Further, the present invention can be provided in large scale format so as to provide a life-size bridge after assembly, which people can then walk across.

### BRIEF DESCRIPTION OF THE DRAWINGS

FIG. 1A shows an illustrative black and white diagram of a sample complete solution for use in accordance with one embodiment of the invention.

FIG. 1B is a representative diagram illustrating connection of one rope element to one ring member for use in accordance with the present invention.

FIGS. 2 through 4 show illustrative black and white diagrams of the left, center, and right sections, respectively, of the sample complete solution of FIG. 1.

FIGS. 5, 6, 7, and 8 reflect tie diagrams shown FIGS. 1, 2, 3 and 4, respectively, with color and/or color and length labels added.

FIGS. 9, 10 and 11 show individual arrangements of parts used in configuring the patterns shown in FIGS. 5 through 8 in accordance with one embodiment of the present invention.

FIG. 12 is a schematic diagram showing a computer network architecture for implementing the learning game and method in a computerized environment in accordance with one embodiment of the present invention.

### DESCRIPTION OF THE PREFERRED EMBODIMENTS

The present invention can operate according to written instructions provided with the game elements described herein. The game elements comprise one or more sets of pattern builder elements. The pattern builder elements include one or more rope cord sections secured to a ring member. A set of pattern builder elements can be several combinations of rope cord-ring member elements. The game elements further include several different pattern images or “solution” diagrams, wherein each pattern image comprises a visual image of at least some of the pattern builder elements in the set.

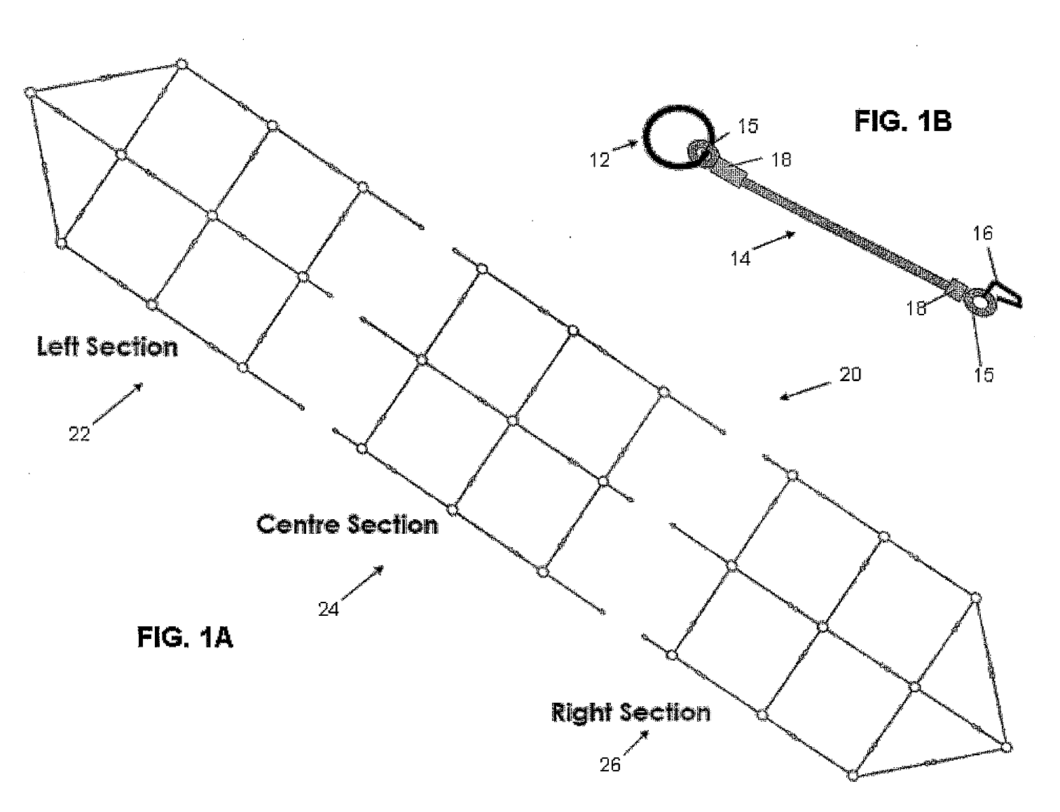

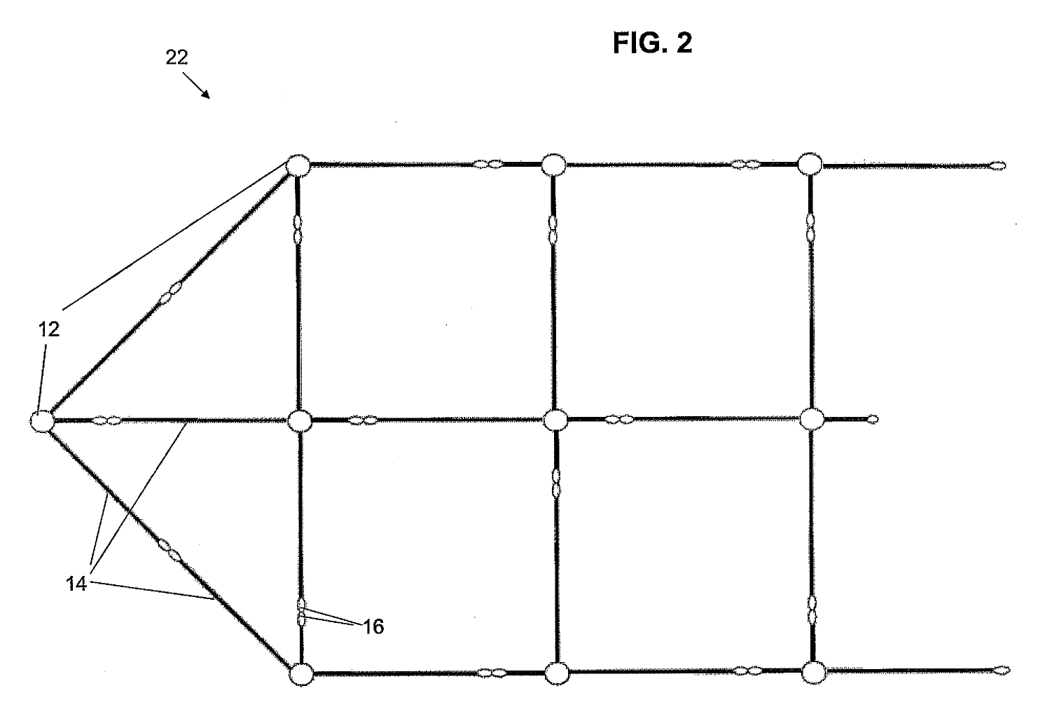

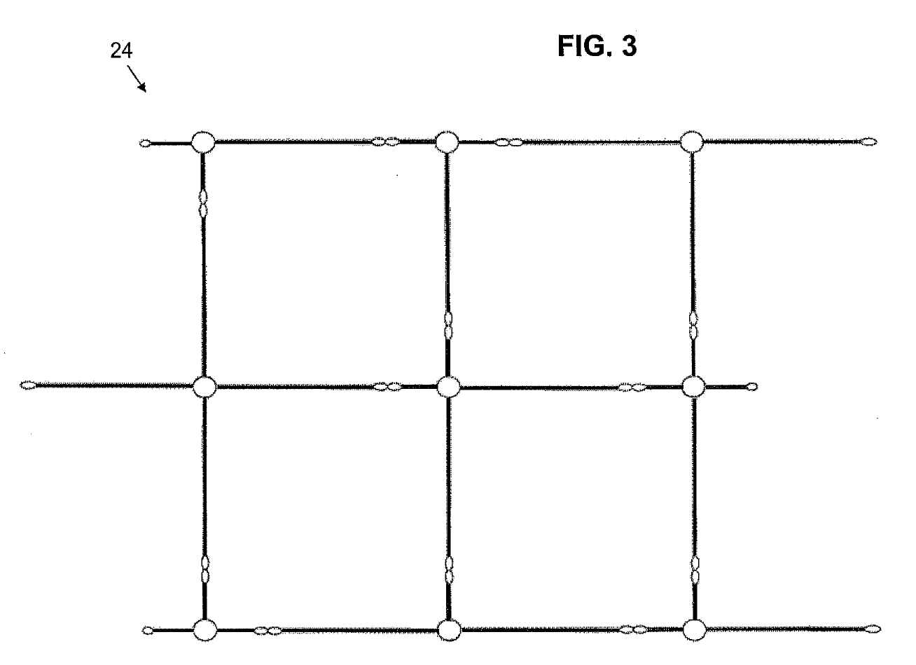

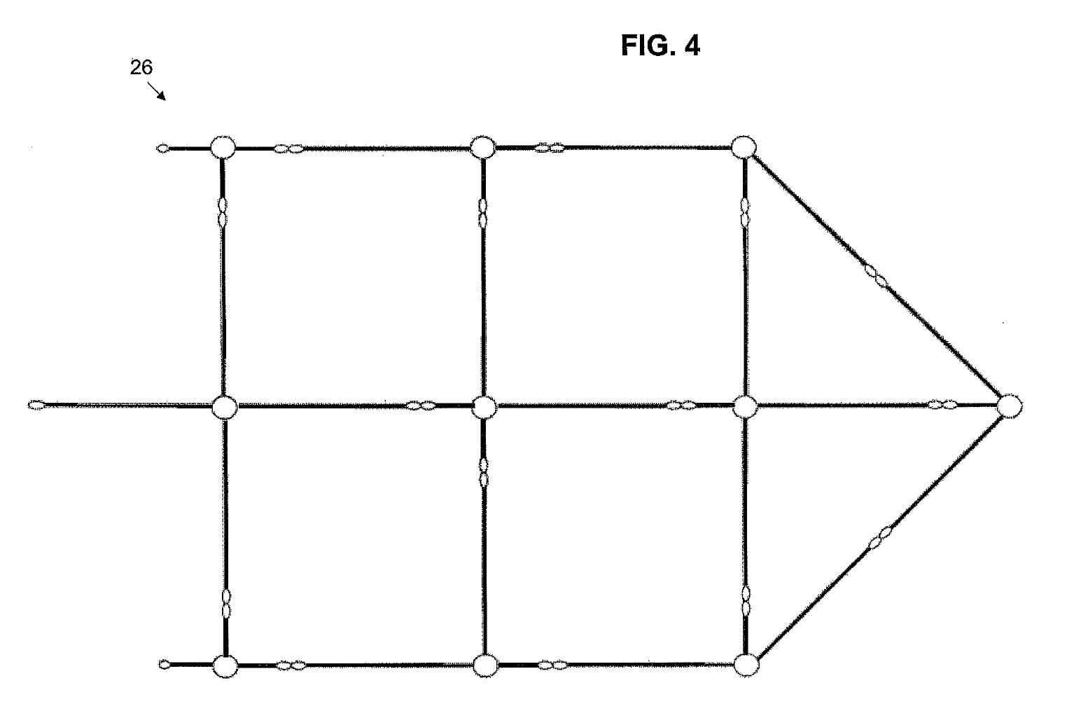

FIG. 1A shows a sample solution diagram 20 in black and white, such as may be provided in accordance with the present invention. The diagram 20 can have a left section 22, center section 24 and right section 26 labeled on the diagram, for example. The left section 22, center section 24 and right section 26 are shown in greater detail in FIGS. 2 through 4, respectively, and the present invention can operate such that multiple solution diagrams of different aspects of a solution are divulged. For example, participants playing a game in accordance with the present invention can be given just the diagram in FIG. 1A or may be given the diagrams of FIGS. 1A and 2 through 4.

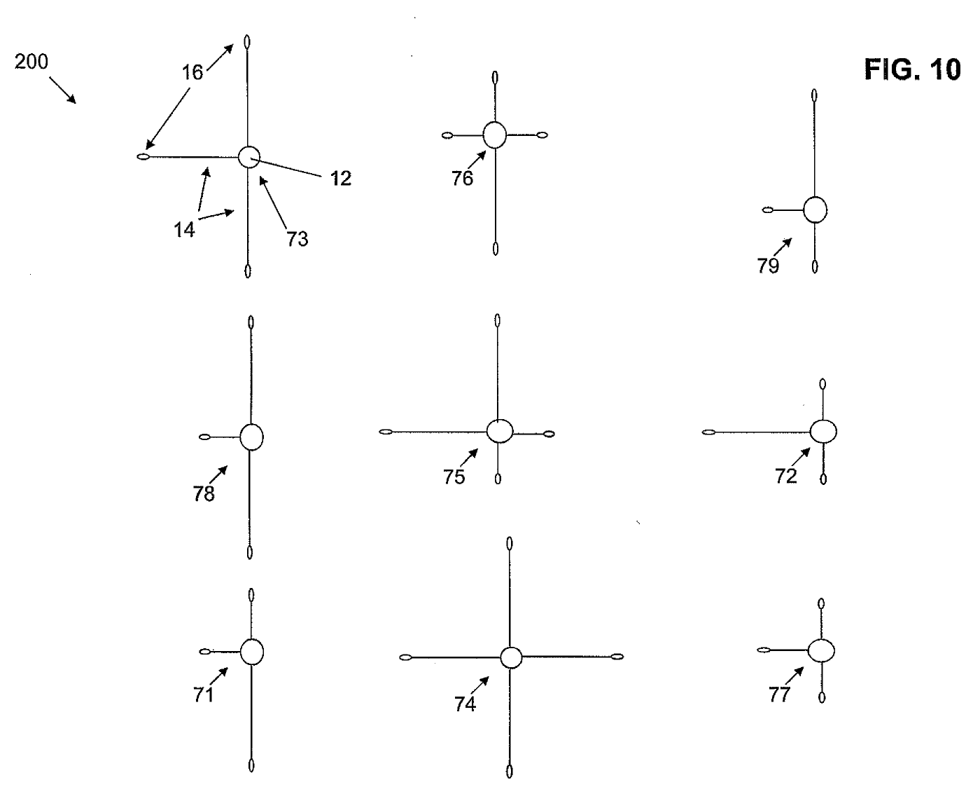

The sections comprise a combination of pattern builder elements, as illustrated in FIGS. 1B, 2 and 9 through 11. As shown therein, each pattern builder element comprises a single welded metal ring 12 (e.g., approximately 1.25 inches in diameter), with a unique combination of typically three or four colored braids or rope sections 14. In one embodiment of the present invention, the braids are approximately 4 mm in diameter, and each braid has a small clipping element 16 (e.g., trigger hook or clip) at its outer end to enable connection to other braids. In another embodiment of the present invention, the thickness of the braids (i.e., rope segments) can be varied, which can either add or reduce the complexity of the game. A plastic molding 18 can be provided at the outer end of each braid to seal the rope section or bight and enable it to retain the trigger clip 16. On the inner end, each braid can be provided with a separate plastic molding and optional clipping element to seal the rope section/light onto the metal ring. In one embodiment of the present invention, as shown in FIG. 1B, rope end loops 15 are provided at each end of each rope section and sealed by the molding element 18 in order to provide adequate attachment capabilities for the ring 12 and the hooklclip 16.

The rope cord sections attached to a given ring member can be of varying length and color. Further, the rope cord sections attached to one ring member can be different in length and color from rope cord sections attached to a separate ring member. In one embodiment of the present invention, at least one of the rope cords attached to a first ring member is different in color and/or length from at least one other of the rope cords attached to a second ring member.

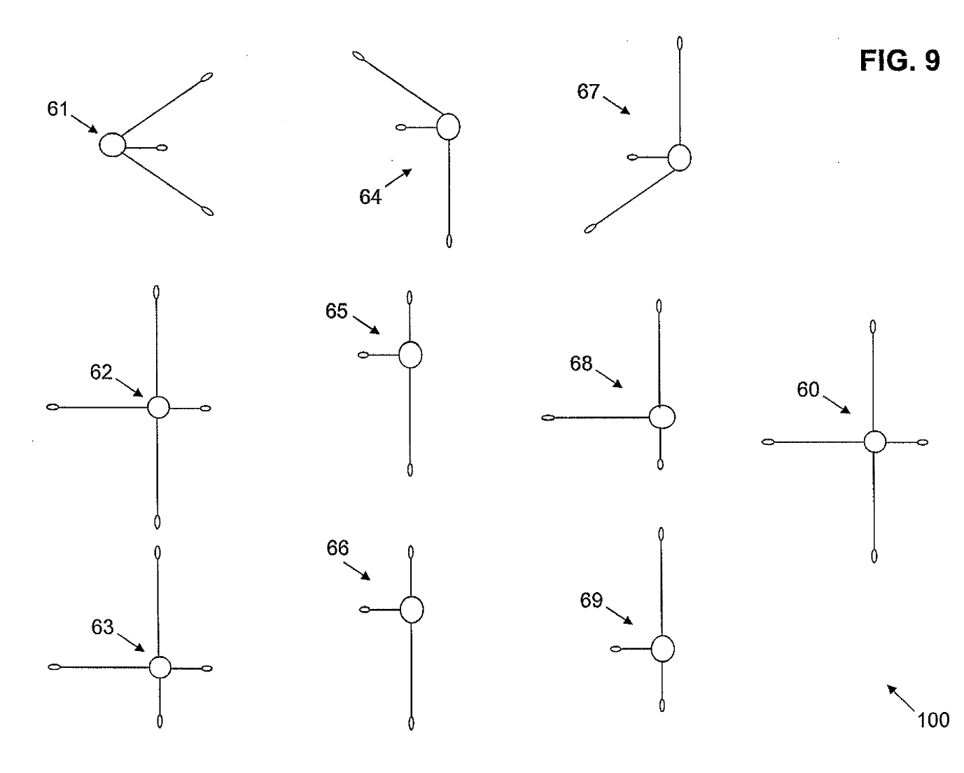

Each pattern builder element (e.g., rope sections secured to a ring member) can have a specific color and length combination, and the present invention can categorize and label each different pattern builder element for purposes of organization, stocking and packaging. When opening the game apparatus of the present invention from a complete game apparatus package, the purchaser/user should be able to accurately compare the different pattern builder elements with an inventory list included in the package. FIGS. 9 through 11 show examples, respectively, of left section pattern builder elements 100, center section pattern builder elements 200 and right section pattern builder elements 300 for the pattern image shown in FIGS. 1 through 8.

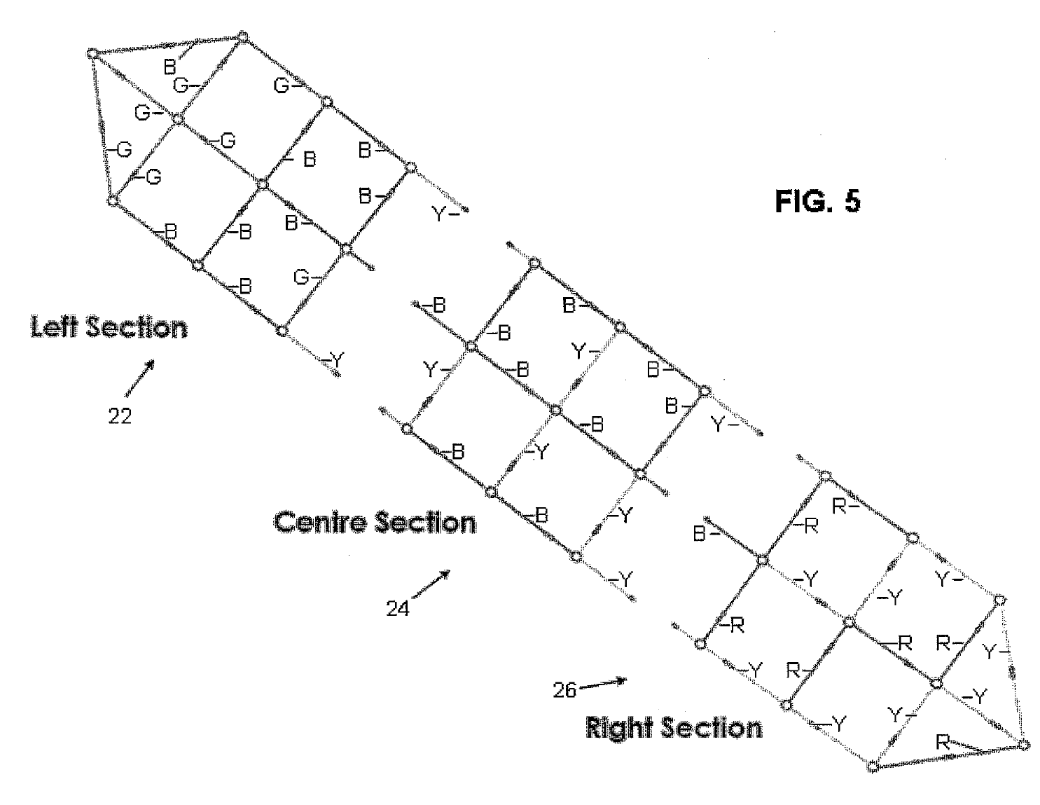

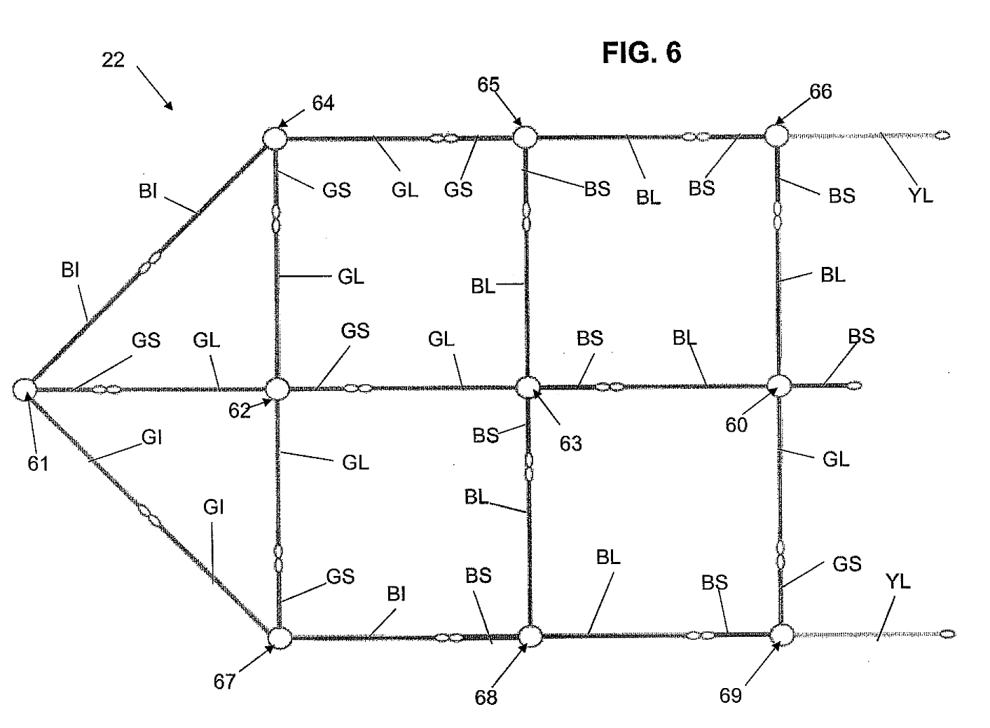

As shown in FIGS. 5-11, multiple color and length combinations are possible and provided as part of the present invention. In FIG. 5, for example, the color blue is indicated for various segments by the letter “B”, the color red is indicated by the letter “R”, the color yellow is indicated by the letter “Y” and the color green is indicated by the letter “G”. In FIGS. 6 through 8, for example, the color is indicated as in FIG. 5; however, the length is also indicated by a letter next to the color, where “S” stands for short, “L” stands for long and “I” stands for intermediate. Thus, as shown in FIGS. 6 through 8, the two letter indicators represent the color and relative length of each rope element within the pattern builder elements. For example, “BS” means a short blue section, “BI” means an intermediate length blue section and “BL” means a long blue section. FIGS. 9 through 11 show the individual pattern builder elements with central ring labeling that corresponds to the location within the assembled section of FIGS. 6 through 8, respectively. Thus, for example, as shown in FIG. 9, element 61 corresponds to the element 61 in FIG. 6, whereby the element includes a short green rope member, an intermediate green rope member, and an intermediate blue rope member. Element 62 includes three long green members and a short green member. Element 63 includes two short blue members, one long blue member, and one long green member. Element 60 includes two long blue members, one long green member and one short blue member. Element 64 includes a short green member, a long green member and an intermediate blue member. Element 65 includes a short green member, a short blue member and a long blue member. Element 66 includes two short blue members and one long yellow member. Element 67 includes an intermediate green member, an intermediate blue member and a short green member. Element 68 includes two long blue members and one short blue member. Element 69 includes a short blue member, a short green member and a long yellow member.

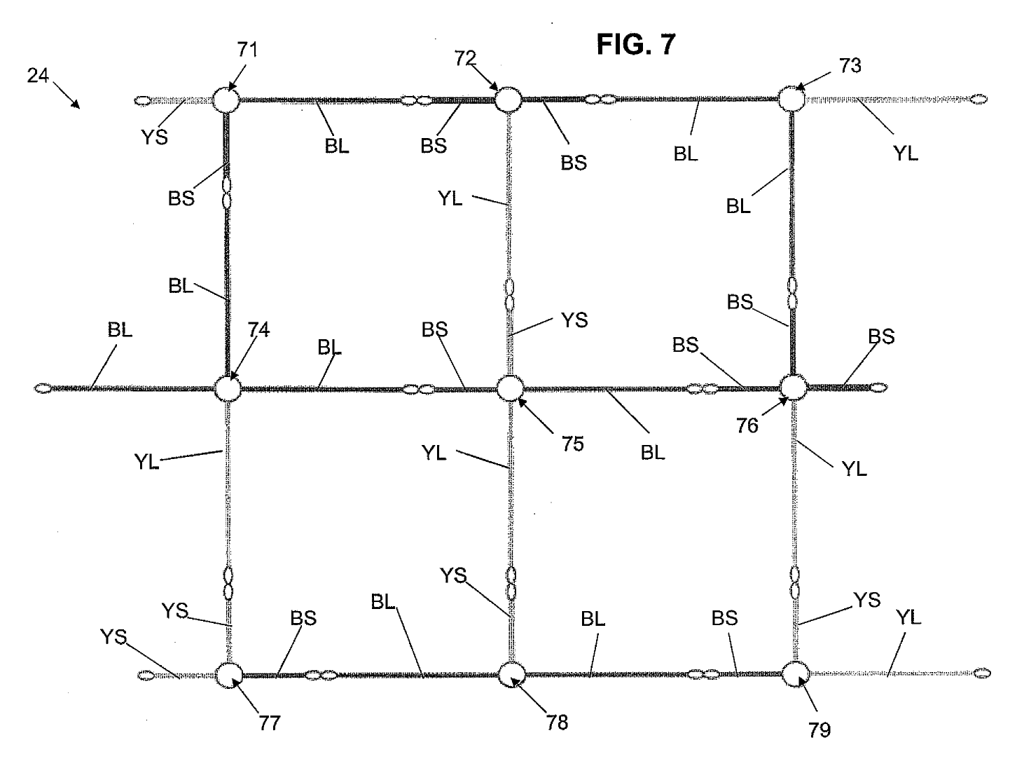

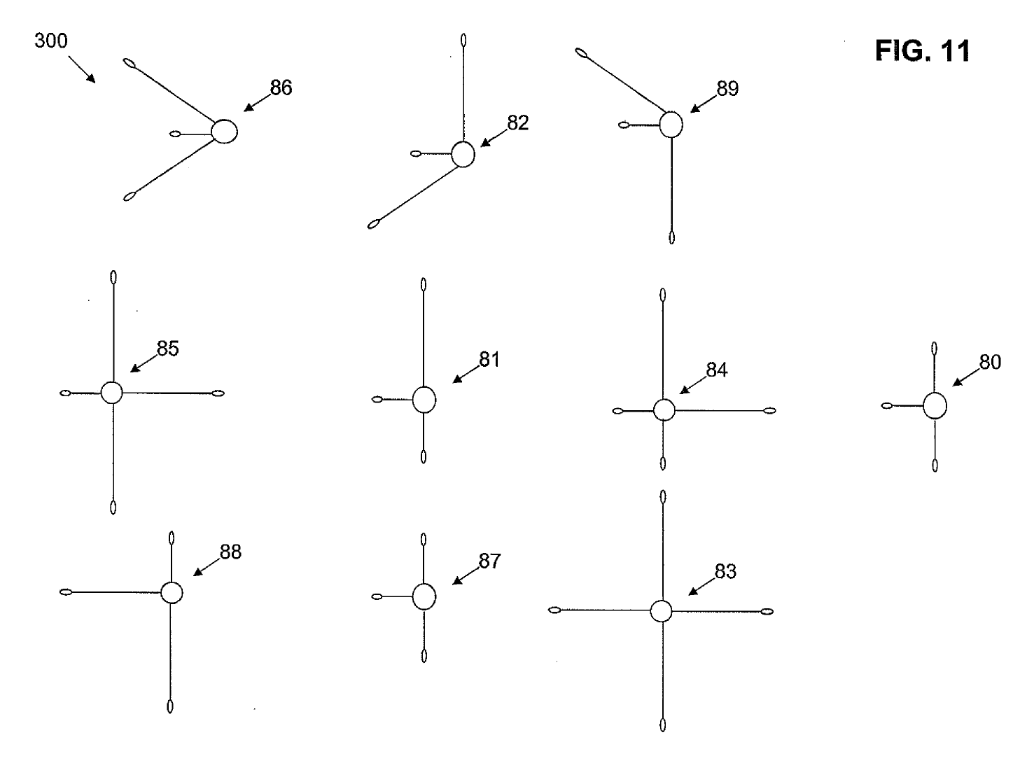

As shown in the example center section 24 of FIG. 7, corresponding to center section elements 200 in FIG. 11, element 71 includes a short yellow member, a short blue member and a long blue member. Element 72 includes two short blue members and a long yellow member. Element 73 includes two long blue members and one long yellow member. Element 74 includes three long blue members and one long yellow member. Element 75 includes a short blue member, a short yellow member, a long blue member and a long yellow member. Element 76 includes three short blue members and a long yellow member. Element 77 includes two short yellow members and one short blue member. Element 78 includes two long blue members and one short yellow member. Element 79 includes a short blue member, a short yellow member and a long yellow member.

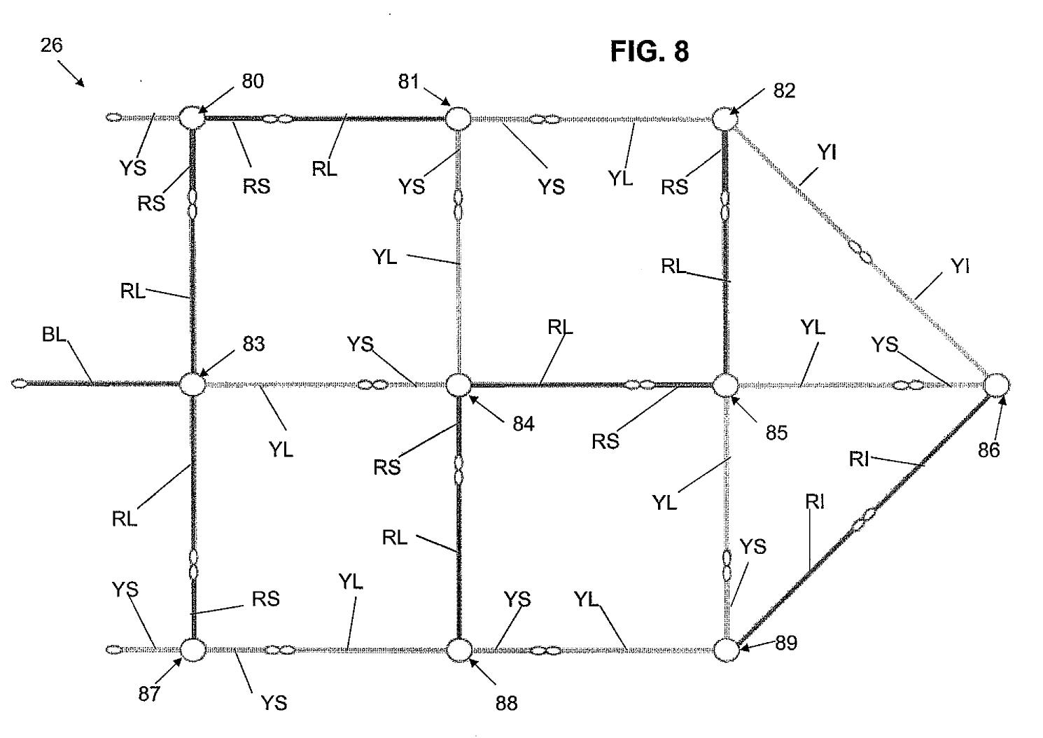

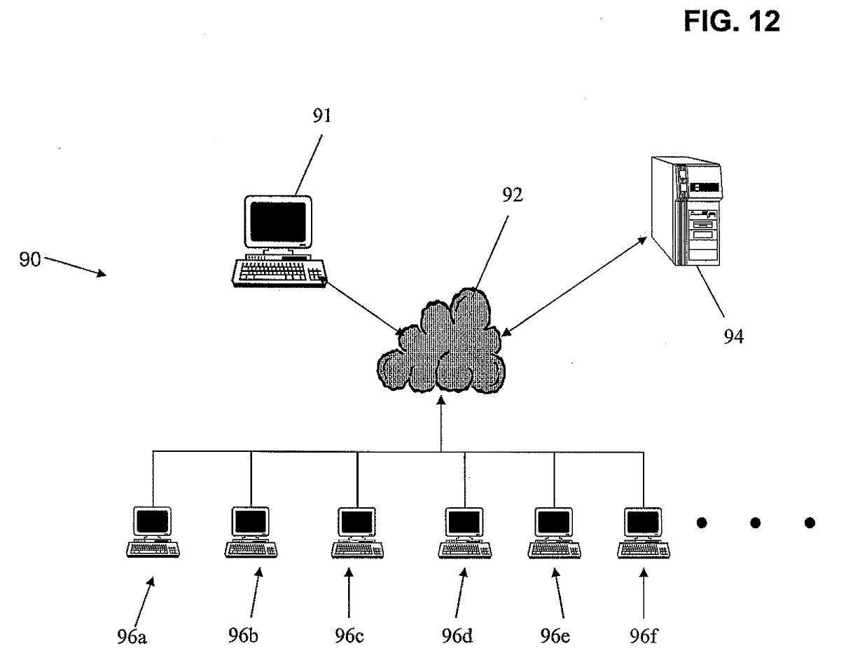

As shown in the example right section 26 of FIG. 8, corresponding to right section elements 300 in FIG. 12, element 80 includes one short yellow member and two short red members. Element 81 includes two short yellow members and one long red member. Element 82 includes a long yellow member, a short red member and an intermediate yellow member. Element 83 includes a long blue member, two long red members and a long yellow member. Element 84 includes one short red member, one short yellow member, one long yellow member and one long red member. Element 85 includes one short red member, one long red member and two long yellow members. Element 86 includes one short yellow member, an intermediate yellow member and an intermediate red member. Element 87 includes two short yellow members and one short red member. Element 88 includes one short yellow member, one long yellow member and one long red member. Element 89 includes one short yellow member, one long yellow member and one intermediate red member.

Members of one section can be connected to members of other sections (e.g., the long yellow member of left section ring 66 in FIG. 6 is intended to be connected to the short yellow member of center section ring 71 in FIG. 7 in the specific illustrative solution described herein); however, these sections can be shown as broken apart in FIGS. 1A and 5 for the sake of discussion of this embodiment of the present invention. Further, given assembly guidelines as illustrated below, where, for example, each rope element of a given color is intended to connect with a rope element of the same color, FIG. 5 is shown with a single color descriptor label applied to each joined link in the overall diagram. Thus, instead of identifying two yellow rope members between a given pair of ring members, for example, the single color yellow is identified with an “L” in FIG. 5.

It will be appreciated that the arrangements described above and illustrated in the drawing figures represent but one of many different configurations that can be employed in accordance with the present invention. Thus, more than four colors and more than twenty-nine total pattern builder elements may be used. Also, fewer than twenty-nine elements may be used, such as, for example, where twenty elements comprising only the left and right sections of FIGS. 6 and 8 are employed.

The complexity and difficulty in matching a given pattern image or diagram is increased with the addition of each pattern builder element having a different color and length combination. In one embodiment of the present invention, a pattern builder element having rope segments in a first color and length combination includes at least two different rope segment colors and at least two different rope segment lengths, while a pattern builder element having rope segments in a second color and length combination also includes at least two different rope segment colors and at least two different rope segment lengths, such that at least one of the colors in the first color and length combination is different from at least one of the colors in the second color and length combination. An example of this embodiment is shown in FIG. 6, where the first color and length combination for the first pattern builder element 61 (i.e., a short green rope member, an intermediate green rope member, and an intermediate blue rope member) differs from the second color and length combination for the second pattern builder element 62 (i.e., three long green members and a short green member).

Instructions for operating the game in accordance with the present invention can accompany the packaging containing the pattern builder elements, the pattern images or solution diagrams and the optional element inventory list. Sample instructions can appear as follows:
1. Identify (if appropriate) the team leader. Give the team leader the activity briefing sheet and the three section black-and-white construction diagrams (see FIGS. 2 through 4 for exemplary diagrams).
2. Allocate the component pieces (i.e., pattern builder elements) at random.
3. Explain and outline the physical play area where the team will be working.
4. Explain the nature of the exercise: a timed period of trial and error experimentation, planning and rehearsal, followed by a single attempt to assemble the structure, within a tightly controlled time period.
5. Agree on the time frame with the group (e.g., forty-five minutes of rehearsal time followed by a two minute assembly period officially “against the clock”).
6. Explain that during the planning and rehearsal period, the participants may pick up and move the pieces, assemble the structure in whole or in part and draw diagrams. They may not mark the individual construction components or the design plans (i.e., pattern images/diagrams) in any way.
7. Explain that at the end of the planning and rehearsal period you will take all of the components from the group and will place them on the floor in a random pile. This means that any partial assembly or “sorting” system which has been created by the group will be undone.
8. During the rehearsal process, do not intervene. Monitor the time and at the end of forty-five minutes (or the agreed planning period), ask the group to stop working.
9. Collect and mix up the components, leaving them in a random pattern.
10. Tell the group to be ready to assemble the structure within two minutes.
11. Start the clock, time two minutes and stop the group at the end of their allotted time.

As described above, FIGS. 1A and 2 through 4 represent sample solution pattern images. The black and white diagrams given to the team leader in instruction #1 can correspond to the diagrams in FIGS. 2 through 4, for example. In an alternative embodiment of the present invention, the color images as represented by any of FIGS. 5 through 8 can be presented as the solution diagrams, which should assist the participants in organizing and arranging the pattern builder elements to match the solution pattern more quickly.

In instruction #2, the individual component pieces are allocated at random. Thus, for example, one individual may receive two short red pieces of rope and a longer green piece extending from a metal ring. Another individual may receive three rings having various combinations of rope cord sections having different colors and different lengths, and so on. As described in step #3, the team can be instructed as to where it will work. In one embodiment of the present invention, the pieces are of such length and the number of players of such anticipated size that it is preferable to allocate at least seven to ten meters of space.

As described in steps #4 through 7 above, instructions are provided to the group in accordance with one or more variations of the game. Step #8 indicates that the components can be collected and mixed in a random pattern for the group to use.

It will be appreciated that learning through the present invention relates largely to the planning and implementation processes. Each team participating in the game needs to plan an initial process for gathering the information required to construct the structure. They then need a period of trial and error and a detailed recording system as a means of identifying and sorting the components. They further need to create an operational plan for the final, timed, high pressure assembly. For example, one team may assign Participant A to collect various rings with pieces of a given color. Participant B may be assigned to oversee the building of the left section, and so forth. As the players learn from experience and the genuine constraints of the present system, they can relate such experiences to workplace planning, decision-making and implementation processes from other contexts.

In one embodiment of the present invention, a budget can be allocated and points awarded based on performance. Thus, the group's task can be to maximize profit given specific rules. For instance, an award of 10,000 points can be given to any group that completes the activity within the two minute time period. A bonus of 1,000 points can be given for every 10-second span below the two minutes, such that completion of the task in one minute, forty seconds results in a 2,000 point bonus. Points can also be deducted based upon “purchase” of hints during the exercise. For example, black-and-white diagrams can be provided at the beginning of the exercise, and colored diagrams can be made available at any stage in the exercise at a cost (e.g., two thousand points per diagram).

In another embodiment of the present invention, each team can be sub-divided into multiple sub-teams and sent to different working areas. Restrictions on collaboration can be placed, such as, for example, only permitting face-to-face meeting with other sub-teams for one minute before the final two-minute time trial. In this variation, the teams are forced to work in environments and with restrictions that mimic common workplace situations. In one embodiment, a communication system can be established between the sub-groups, which can be by telephone, delivery and collection of written notes, selected representative in-person meetings.

The budget, remote working, hint and other elements of the present invention can be combined and varied depending upon the facilitator's objectives and the ability of the participants.

As shown in FIGS. 6 through 9, the color labels illustrate various aspects of the physical elements of the present invention. For example, there are red, blue, yellow and green pieces of rope. Each piece of rope has a relative size, such as short, intermediate or long. As discussed above, the color and relative size indicators are represented on the diagrams as abbreviations (e.g., “BL” stands for long blue, “RI” stands for intermediate red, and so on). There are also connector members illustrated by numeral 15 and rings illustrated by numeral 12 in FIG. 1B. It will be appreciated that the present invention generally works with individual cord sections (e.g., three or four) secured to a ring prior to beginning the game and/or training as described below.

Further details of a complete set of parts in one embodiment of the present invention are shown and described in FIGS. 9 through 11. As shown therein and in the given embodiment, each full set can comprise twenty-nine (29) component pieces, supplied on two split display rings. One display ring can contain twenty (20) component pieces as needed for the left and right sections, and another display ring can contain nine (9) component pieces for the center section. Thus, it will be appreciated that each of the twenty-nine components in the embodiment of the present invention represented by FIGS. 9 through 11 is a unique combination of braids in total number, color and length. It will further be appreciated that the arrangement in FIGS. 9 through 11 represents merely one of hundreds of combinations of colors, lengths, and numbers of braids connected to a given metal ring.

In accordance with one aspect of the present invention, various assembly guidelines can be applied and provided to the game participants. For example, assembly guidelines may be provided as follows:
a. On any ring, there will be cord sections of either two or three different lengths.
b. On any ring, there will be cord sections of between one and three different colors.
c. These cord sections connect to each other as follows:
   Red always connects to Red
   Blue always connects to Blue
   Green always connects to Green
   Yellow always connects to Yellow
   Short always connects to Long
   Long always connects to Short
   Intermediate always connects to Intermediate

It will be appreciated that intermediate links will be shorter than long links, yet longer than short links. In one embodiment of the present invention, the difficulty and complexity of the invention is increased by providing intermediate links that vary in length from either the short or long links by only a small distance (e.g., 2.5 cm).

In a further embodiment of the present invention, a solution pattern image can be provided that, when assembled using the pattern builder elements, can be arranged to operate as a physical bridge. The bridge can be employed as a further learning experience and type of reward for correctly assembling the pattern builder elements. In this embodiment, the invention may incorporate a bridge frame or support structure which can hold the outer elements of the assembled pattern builder elements in order to adequately support the weight of any participant who may walk across the now-suspended pattern builder elements. Alternatively, the ends of the assembled pattern builder elements can be tied around a tree or other supporting structure. The means for connecting the assembled pattern builder elements to a bridge frame, tree or other support can be the hooks described above or any suitable connection means known to support rope bridges.

As shown in FIG. 12, the present invention contemplates that the use of a computer 91 can facilitate the creation and modification of the learning game described herein. For example, the various colors and lengths can be modified to provide a more or less complex game, depending upon the skill levels and experience of the players involved. In one embodiment of the present invention as shown at 90 in FIG. 12, an administrative user 91 can communicate over a network 92 to a central server 94 to design the game with appropriately sized and colored elements to meet the desired complexity of the game. In one embodiment, central server 94 can be affiliated with a parts manufacturer or distributor who can fill orders as they are placed by user 91. In another embodiment of the present invention, server 94 can produce electronic equivalents of the various elements that can then be used by users 96a-f (or as many users as desired) in an electronic version of the game. It will be apparent to one skilled in the art that any computer system that includes suitable programming means for operating in accordance with the disclosed methods also falls well within the scope of this aspect of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system. The present invention can further run on a variety of platforms, including Microsoft Windows™, Linux™, or other platforms, for example.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A method of playing a game, comprising:
(a) providing a playing area;
(b) providing at least one set of pattern builder elements including at least one builder element comprising a plurality of rope cord sections secured at respective first ends thereof to a ring member;
(c) providing at least one player with a solution pattern image to be matched by the pattern builder elements; and
(d) forming the pattern builder elements to match the solution pattern image.

2. The method of claim 1, wherein step (b) further comprises providing the plurality of rope cord sections with a clipping element at respective second ends thereof to permit securing of a pair of rope cord sections to one another.

3. The method of claim 1, wherein step (c) comprises providing a black and white assigned pattern image.

4. The method of claim 1, wherein the plurality of rope cord sections in step (b) are provided in one or more colors.

5. The method of claim 1, further comprising setting a time limit for completion of step (d).

6. The method of claim 1, wherein step (c) further comprises forming a team with one or more team members in addition to the player, wherein the player is a leader, and further comprising the step of allowing communication between the leader and the one or more team members.

7. The method of claim 1, wherein step (c) further comprises forming a plurality of teams, and further comprising the step of determining which of the plurality of teams is the first to finish step (d).

8. The method of claim 1, wherein step (c) comprises selecting pattern images from a group of easy images and from a group of difficult images.

9. The method of claim 1, wherein the game is played in a plurality of rounds, and wherein, for each round, step (c) is performed by assigning different pattern images.

10. A method of training a group of employees, comprising:
(a) dividing the group into teams, each team being associated with a set of pattern builder elements including at least one pattern builder element comprising a plurality of rope cord sections secured at respective first ends thereof to a ring member;
(b) assigning a solution pattern image to a leader of each team, each solution pattern image comprising a visual image of at least some of the pattern builder elements in the set; and
(c) initiating a race between the teams for determining which team can first complete the task of forming the solution pattern image using at least some of the pattern builder elements in the set.

11. The method of claim 10, wherein step (a) further comprises providing the plurality of rope cord sections with a clipping element at respective second ends thereof to permit securing of a pair of rope cord sections to one another.

12. An apparatus for playing a management training game, comprising:
at least one set of pattern builder elements including two or more pattern builder elements comprising a plurality of rope cord sections secured at respective first ends thereof to a ring member; and
a plurality of solution pattern images, each solution pattern image comprising a visual image of at least some of the pattern builder elements in the set.

13. The apparatus of claim 12, wherein the plurality of rope cord sections are provided with a clipping element at respective second ends thereof to permit securing of a pair of rope cord sections to one another.

14. The apparatus of claim 12, wherein the plurality of rope cord sections includes rope cord sections of varying length.

15. The apparatus of claim 12, wherein the plurality of rope cord sections includes rope cord sections of varying color.

16. The apparatus of claim 12, wherein a first one of the two or more pattern builder elements comprises a plurality of rope cord sections of a first color and length combination, and wherein a second one of the two or more pattern builder elements comprises a plurality of rope cord sections of a second color and length combination, and further wherein the first and second color and length combinations are different.

17. The apparatus of claim 16, wherein the first color and length combination includes at least two different colors and at least two different lengths, and wherein the second color and length combination includes at least two different colors and at least two different lengths, and further wherein at least one of the colors in the first color and length combination is different from at least one of the colors in the second color and length combination.

18. The apparatus of claim 12, wherein the pattern builder elements are assembled and operated as a physical bridge.

19. A configurable learning system, comprising:
a computer-implemented program for operating a learning game, the game including:
a plurality of rings; and
a plurality of cords of different color and length capable of being fixedly secured to one or more of the plurality of rings.

20. A method for developing a learning system, comprising the steps of:
providing at least one set of pattern builder elements including two or more pattern builder elements, each comprising a plurality of rope cord sections secured at respective first ends thereof to a ring member; and
providing a plurality of solution pattern images, each solution pattern image comprising a visual image of at least some of the pattern builder elements in the set.
